(19) United States
(12) Patent Application Publication
(10) Pub. No.: US 2014/0236841 A1
(43) Pub. Date: Aug. 21, 2014

(54) SYSTEM AND A METHOD FOR RECEIVING AND DISBURSING DONATION

(71) Applicants: Seng Chuan Tan, Singapore (SG); Meng Lye Sit, Singapore (SG)

(72) Inventors: Seng Chuan Tan, Singapore (SG); Meng Lye Sit, Singapore (SG)

(73) Assignee: NUMONI PTE LTD, Singapore (SG)

(21) Appl. No.: 14/346,005

(22) PCT Filed: Aug. 16, 2012
(86) PCT No.: PCT/MY2012/000232

§ 371 Date: Apr. 10, 2014

(30) Foreign Application Priority Data
Sep. 20, 2011 (MY) PI 2011004449

(51) Int. Cl. G06Q 20/40; G06Q 20/32; G06Q 30/02

(52) U.S. Cl. CPC G06Q 20/4012; G06Q 30/0279; G06Q 20/3278; G06Q 20/40145
USPC 705/72

(57) ABSTRACT

A system for facilitating the transaction of donation funds is disclosed. The system allows for the collection and disbursement of recurring donations. The system comprises a plurality of donors (110), at least one donation collecting institution (120) and a plurality of recipients (130). The plurality of donors (110) contribute donations to the donation collecting institution (120) in which the donations are gathered to form a pool of donation funds. The pool of donation funds is supervised and controlled by at least one global entity (125) which disburses and distributes the pool of donation funds to the plurality of recipients (130) via a plurality of kiosk terminals in the form of mobile airtime credit and mobile wallet points.

### FIELD OF INVENTION

The present invention relates to donation funds transaction. More particularly, the present invention relates to a system and a method for facilitating the transaction of donation funds by receiving the funds from the donors and disbursing the funds to the recipients via a plurality of kiosk terminals.

### BACKGROUND OF THE INVENTION

Donations, including religious donations such as the tithes, ‘zakat’, and alms giving in a religion such as Muslim religion (the zakat) can be carried out on a recurring basis, usually annually, but may also be carried out throughout the year. Donors contribute monies with the hopes that their donation can reach the appropriate recipients and help the recipients financially.

Donors often prefer to give their monies directly to individuals, eliminating middle men. Donation collecting institutions are often obliged to disburse the donation funds within a specific time-frame, especially before the festivities such as Muslim festivities (for the case of the zakat) or within the same year as when the donations are received from the donors. Since disbursement of the donation funds to individuals or homes may be arduous and laborious, and especially difficult within a short time-frame, donation collecting institutions resort to using the donations for developmental projects such as building schools and other facilities to improve the lives of the poor and the needy. These developmental projects would allow large sum of the donation funds to be disbursed. However, these developmental projects, while it may be useful to the poor and needy community, may neglect the financial needs of the poor and the needy, thus defeating the fundamental purpose of the donation.

The challenge is how donation collecting institutions can utilize donation funds by distributing the funds EQUITABLY to poor and needy individuals. Such distribution of the donation funds may be achieved through electronic fund transfer (EFT) such that the appropriated funds are wired to each recipient. However, this would be virtually impossible to carry out, considering the poor and needy individuals usually do not possess a bank account due to their inability to gain access to financial institution and banks alike.

Donations that are collected by non-religious organisations including non-government organisations (NGOs) can be collected with a specific purpose or a non-specific purpose. These organisations face similar challenges as the religious organisations if they are in need to conduct donor fund disbursement rapidly within a short time frame if relief aide is required or if there is a limitation on the organisation to ensure that the funds are distributed to the needy individual.

Using ‘zakat’ as an example, zakat is most frequently contributed before the Muslim festive season. In the Muslim tradition, it is vital that the contribution of zakat reaches the recipients in a timely and orderly fashion. It would also be an additional advantage if the recipients of the donation can be traced to ensure that the recipients are deserving of the donations appropriated to them.

The zakat donation however, is usually coordinated by numerous institutions or facilities which become the “middle person” of the transaction before the donation actually reaches the recipients. The middle person may take a percentage of each donation from the donors to in order to sustain the operation of the donation collecting institutions or facilities. The operational cost of these institutions may constitute a large sum since the donation funds disbursement is usually manually handled by a large number of employees instead of being an automated process.

Numerous prior arts have disclosed methods and system for the handling of donation funds such as U.S. Pat. No. 509,794 which disclosed a donation transaction apparatus and a method for facilitating donations to charitable organizations. The donation transaction apparatus disclosed allows the donors to select an organisation in which their donations will be directed to. The donations will be wired to the organisation's bank account. The prior art therefore, does not propose a method to disburse donations funds to poor and needy individuals without bank accounts and also does not collect the donation into a donation funds pool to be distributed.

Yet another prior art, US patent publication 2004/0267650 disclosed a method and a system that electronically collects monies from donors and organisation and distributes the collected monies to designated charitable and other non-profit organisation such as churches. The system essentially allows donors to donate to an organisation in a most convenient manner while deciding the frequency and amount of donation. The donations however, are also achieved via fund transfer from the donors account to the organisation's account. This therefore, does not serve the purpose of donating to individuals, particularly poor and needy individuals who do not usually have access to bank accounts.

Therefore there is a need for a system and a method for facilitating the transaction of donation funds from the donors and disbursing the funds to the recipients who do not possess a bank account and to do it rapidly, meeting either deadlines for the disbursements or deadlines based on the specific needs of the recipients.

### SUMMARY OF INVENTION

Accordingly, it is a primary object of the present invention to provide a system and a method for facilitating the transaction of donation funds by receiving the funds from the donors and disbursing the funds to the recipients via a plurality of kiosk terminals.

It is another object of the present invention to disburse and distribute a pool of donation funds to a plurality of recipients who does not possess a bank account.

It is another object of the present invention to disburse and distribute an appropriated amount of the donation funds to the recipient in the form of mobile airtime credit or mobile wallet points or notations in a mobile wallet system that are deemed to carry monetary value as accepted by the local authorities, ie., ‘mobile money’.

It is yet another object of the present invention to disburse and distribute an appropriated amount of the donation funds to the recipient by topping up the mobile airtime or mobile wallet.

It is further another object of the present invention to provide a plurality of kiosk terminals to the recipients for allowing the recipients to receive the donation funds by providing at least one identification and a mobile phone number.

To fulfill the aforementioned objectives, a system for facilitating the transaction of donation funds a system for facilitating the transaction of donation funds is utilised. The system allows for the collection and disbursement of recurring donations. The system comprises a plurality of donors, at least one donation collecting institution and a plurality of recipients. In a preferred embodiment, the plurality of recipients are registered within the system and in a database of the donation collecting institution. The recipients are recognised as the poor and needy who are deserving of the donation funds when they registered with the donation collecting institution.

The donation collecting institution may be a group of institutions. The group of institutions may represent different countries to serve as a focal point for the collection of donation from donors from a particular country. The group of institutions is managed by at least one global entity which provides a donation disbursement service to the plurality of recipients upon receiving the donation from the donors. The global entity supervises and processes the information related to the donors and the collected funds. The global entity can also supervise and control the pool of collected funds.

The donation funds are disbursed and distributed to the recipients in the form of mobile airtime credit and mobile wallet points or mobile money. The recipients receive the donation funds from a plurality of strategically placed kiosk terminals. The recipients provide at least one identification to the kiosk terminal to verify their identity. Verifying the identity of the recipient may involve keying in the identity card number, mobile phone number or a Personal Identification Number (PIN) or even by scanning an identity card or the mobile phone itself via a Near Field Communication (NFC). Upon verification of the recipients' identity, the donation funds are disbursed to the recipients' mobile phone as mobile airtime credit or mobile wallet points or mobile money.

The present preferred embodiments of the invention consists of novel features and a combination of parts hereinafter fully described and illustrated in the accompanying drawings and particularly pointed out in the appended claims; it being understood that various changes in the details may be effected by those skilled in the arts but without departing from the scope of the invention or sacrificing any of the advantages of the present invention.

### BRIEF DESCRIPTION OF THE DRAWINGS

These and other features, aspects and advantages of the present invention will be more fully understood when considered with respect to the following detailed descriptions, appended claims and accompanying drawings wherein:

FIG. 1 shows an embodiment of a system for facilitating the transaction of donation funds;

FIG. 2 shows a flow diagram depicting a method for disbursing the donation funds.

FIG. 3 shows a flow diagram depicting a first method of disbursing the donation funds from a kiosk terminal to a recipient.

FIG. 4 shows a flow diagram depicting a second method of disbursing the donation funds from a kiosk terminal to a recipient.

### DETAILED DESCRIPTION OF THE INVENTION

Hereinafter, the present invention shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claim.

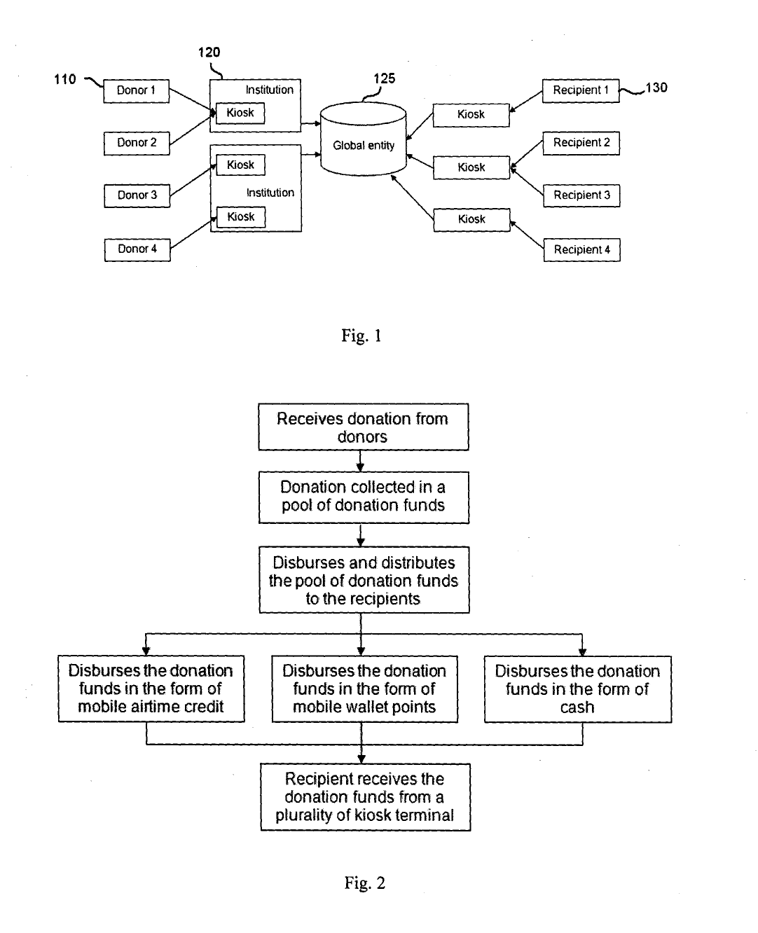

Referring now to FIG. 1, there is shown one embodiment of a system for facilitating the transaction of donation funds. The system may be used for the collection of zakat otherwise known as alms giving by the Muslim religion or the collection of tithes. The system particularly caters to recurring donations which may be collected annually or on a regular basis. In the present invention, the entities contributing the donations are referred to as donors while the entities receiving the donations are referred to as recipients or beneficiaries. The system also caters to donations that are performed on an irregular and ad-hoc basis, or donations sparked off by a crisis that calls for such donations. The system in FIG. 1 comprises a plurality of donors (110), at least one donation collecting institution (120) and a plurality of recipients (130). In a preferred embodiment, the plurality of recipients (130) may be registered in the system as the hardcore poor and in need of financial assistance. Details of the recipients (130) such as the identity card number and mobile phone number are stored in a recipients' details database.

The registration of the recipient may be done prior to disbursement of funds such that an amount of donation funds is appropriated to each recipient. Therefore, upon registration, the recipients are eligible to receive recurring disbursement of fund to them. Otherwise, the recipients may also register or identify themselves at the kiosk terminal and may be disbursed an amount of donation funds if they are categorised by a national body as hardcore poor, based on the identification provided.

The donors (110) may include but is not limited to institutions, corporations, companies, individuals et cetera. Similarly, the recipients (130) may include but is also not limited to an institution, a corporation, a company, a family or a group, a small community of people, an individual et cetera. The present invention however, caters to the disbursement of donation funds to the recipients (130) via an individual.

The donation collecting institutions (120) may be a group of institutions. The group of institutions may be affiliated to different countries and serve as a focal point for the collection of donations from donors (110) from a particular country. The group of institutions is managed by at least one global entity (125) which provides a donation disbursement service to the plurality of recipients (130) via the group of institutions upon receiving the donations from the donors (110). The global entity (125) is not only restricted to worldwide and international disbursement services, but may also be utilised for regional and national disbursement services wherein the global entity (125) may be aptly renamed as a regional entity or a national entity.

The donations received from the donors (110) are gathered by the global entity (125) to form a pool of donation funds. The global entity (125) supervises and controls a pool of donation funds and allows the donation funds to be disbursed to the recipients (130) at a global level. The global entity may or may not own the equipment and system to perform the functions as named herein, and may outsource such processing and market relationship functions to third parties. The donation funds may be used to fund projects beneficial to the poor and the needy, such as building facilities like schools and low cost houses to improve the quality of life of the poor and the needy. The present invention caters particularly to disbursing the pool of donation funds to poor and needy individuals such that the donations can directly assist the financial needs of the recipients (130).

The donors (110) are provided with a few options for donating funds to respective donation collecting institutions (120) in their country. The donation may be contributed via a plurality of kiosk terminals provided by the collecting institutions (120). Alternatively, donations from the donors (110) may also be received via a cash deposit machine, an Automatic Teller Machine (ATM), electronic funds transfer (EFT) from the donors' bank account to the institutions' bank account, through short messaging service (SMS) instruction, online banking or payroll deduction. Conventionally, the donation may also be accepted through collection counter services provided by the branches of the collecting institutions (120). Donation may also be contributed to the institutions (120) through mobile airtime transfer, wherein airtime is transferred to the institutions (120), in which airtime is converted to a form of currency acceptable by the institutions (120) to be added to the donation funds. Donation may also be in the form of mobile money which represents a monetary value in a mobile wallet system.

It should be noted that the method for receiving donations from the donor (110) are not limited by the aforementioned examples and may be varied or improved in accordance with the advancement of fund transfer technology in time.

In one embodiment of the invention, the donors (110) make donations to the respective institutions (120) via the kiosk terminal. The kiosk terminal may be a cash acceptance terminal, provided with a notes and coins acceptor unit for receiving donations from the donors (110). The notes and coins received by the donors (110) may be collected and stored in a hopper which is securely locked in the kiosk terminal. The cash acceptance function of the kiosk terminal is similar to that of a cash deposit machine. The notes and coins provided by the donor (110) is calculated by the kiosk and information of the donor (110) and the information of the donation denomination is sent to the donation collecting institution (120) for acknowledging the receipt of the donation. Notes and coins collected and stored in the hopper is removed and transferred to a secured facility in the donating collecting institution (120) by an authorised representative of the donation collecting institution (120). The collected cash may be deposited into a bank account of the donation collecting institution (120).

Additionally, the kiosk terminal used by the donor (110) for making donations may also be provided with means for accepting other modes of donation besides notes and coins. The kiosk terminal may be provided with a card reader and sensor for detecting cards with security chip, magnetic stripe et cetera which may include but are not limited to reward cards, point cards, value cards, credit cards or debit cards. The sensor may also be used for detecting donation vouchers or tickets with barcodes on them in which, the kiosk terminal is provided with a barcode scanner. Alternatively, the kiosk terminal may also be provided with means for carrying out near field communication (NFC) for detecting devices such as mobile phones to allow donation via mobile airtime or a mobile point system, otherwise more commonly known as mobile wallet or mobile money

Also similar to a cash deposit machine, the kiosk terminal is provided with a screen which displays the interface of a program installed in the kiosk terminal. The interface guides the donors (110) through the donation process. The donors (110) may select a preferred method of donation. The interface may also allow the donors (110) to key in their name and identification. By keying in the donors' name and identification, the kiosk terminal is able to detect and update the donors' donation fund account. The system of the present invention provides the flexibility for the donors (110) to have a donation fund account to track the donors' donations. The donation fund account is similar to that of a bank account and may be used to track the donation received and may also be used to track if the donations from the donors (110) have been disbursed to a recipient or beneficiary.

In yet another preferred embodiment of the present invention, the donation collecting institution (110) may be affiliated to different states in a country while the global entity (125) coordinates the pool of donation funds at the national level. It should be noted that the function of the donation collecting institution (110) is not restricted to a state or national level, but may be used to coordinate the receipt of donations at a micro level such that receipt of donations can be better monitored and tracked. The global entity on the other hand coordinates the donation fund pool at a macro level to ensure that funds can be disbursed in a more equitable fashion to the highest number of recipients (130) which is within the purview of the global entity (125). Preferably, there is a threshold for each recipients (130), limiting the amount of donation funds permissible to be disbursed to the recipients (130) to ensure that the donation funds are fairly distributed among the recipients (130). The amount of donation funds appropriated to the recipients (130) may also have been determined accordingly based on the financial status of the recipients (130).

In a preferred embodiment of the present invention, the donation funds are disbursed to the recipients (130) via a kiosk terminal. The kiosk terminal used for disbursing the donation funds may be the same kiosk terminal used for receiving the donation funds from the donors (120) or it may be an entirely different type of kiosk terminal, specifically utilised for the disbursement of donation funds to the recipients (130).

The global entity (125) provides the plurality of kiosk terminal, strategically placed in or within the proximity of a poor or needy community, at the highest population of the recipients (130) of the donation funds. The kiosk terminal enables the transfer of the appropriated donation funds to the recipients (130) via the recipient's mobile phone. The transfer may be achieved electronically or by signal exchanges between the kiosk terminal, the terminal's backend and/or the mobile phone. Alternatively, the kiosk terminal may also function like an ATM, wherein cash is dispensed from the kiosk terminal to the recipients (130).

In a preferred embodiment of the present invention, the pool of donation funds controlled by the global entity (125) is disbursed to the recipients (130) as airtime credit or mobile wallet points or mobile money. The donation funds may be used by the recipient (130) to top-up their mobile airtime or mobile wallet points/mobile money. Disbursement of the donation funds in the form of airtime credit or mobile wallet points/mobile money therefore does not require the recipients (130) to have a bank account. Since the poor and the needy do not typically have a bank account registered under their name, the donation funds accepted in the form of cash, airtime credits or mobile wallet points may be used for the purchase of goods, services or other purposes without having to go through the hassle of registering for a bank account and withdrawing cash from an ATM machine which is also most likely, not accessible by the poor and needy community.

Aside from making mobile telephone calls, the mobile airtime credits may be used for value transfer, wherein the mobile airtime credits may be exchanged for goods or services. The mobile airtime credits may be incorporated or interchanged with the value in the mobile wallet, such that airtime may be use to purchase goods or services from participating merchants or service providers associated with the mobile wallet. It should be appreciated that this mode of payment may vary and improve with the advancement of payment and/or mobile transaction processing technologies. The mobile wallet therefore serves its purpose as a virtual wallet, in which the value of cash is represented by the mobile wallet points. The mobile wallet points are virtual cash, used for the purchasing of items either from participating merchants with an online store or participating merchants with means for accepting payment using the mobile wallet at the point of sale of a product or a service via near field communication (NFC). Since the poor and needy community may lack access to financial institutions and banks to create a bank account, but still has access to the usage of a mobile phone, the mobile wallet account incorporated to the recipients' mobile phone is used as a substitute for cash, credit card or debit card.

In a similar fashion as the donors' kiosk terminal, the recipient's kiosk terminal is installed with a program which allows the recipient to key in their particulars to receive the donation via an interface displayed on a screen of the kiosk terminal. The kiosk terminal may comprise an input means, which may be buttons or touch screen to allow the recipients (130) to verify their identity before the fund is disbursed to the recipients (130).

The kiosk terminal further comprises a card reader and sensor for detecting cards with embedded security chips, magnetic stripe et cetera which may include reward cards, point cards, value cards or bank cards. The kiosk terminal may read the contactless chips which may come in a variety of form such as mobile phone insertions. Therefore, the kiosk terminal may disburse the appropriated fund to the recipient via electronic transfer into these cards or directly into the recipients' mobile prepaid airtime account or mobile money account.

However, in the instance that the recipients (130) do not have a bank account, which is the most likely possibility, the recipients' kiosk terminal is also provided with a scanner to establish communication between the kiosk terminal and the recipients' mobile phone such that donation funds may be transferred into the recipients' mobile phone as mobile airtime credit or mobile wallet points.

The card reader, sensor and scanner is also additionally utilised to verify the recipients' (130) identity to ensure that they are registered in the recipients' details database and are appropriated an amount of the donation funds. Verification of the registered recipients' (130) identity prevents wrongful disbursement of the fund. The recipients' (130) identity may be verified by numerous identification means which may include but is not limited to the recipients' identity card, the recipients' mobile phone or through the usage of a Personal Identification Number (PIN). The identity card may comprise a chip identifiable by card reader to verify the identity of the recipient (130). The sensor which may be used for contact or contactless detection of the identification means may be used to detect a barcode or a chip embedded in the mobile phone. Contactless detection may be achieved by near field communication (NFC) system which establishes a connection between the kiosk terminal and the mobile phone for the purpose of data exchange or donation funds transaction.

Referring now to FIG. 2, there is shown a flow diagram depicting a method for disbursing the donation funds to a plurality of recipients (130) from a pool of donation funds. The donors (110) first donate a sum of fund to the donation collecting institution (120). Upon receiving the donations from the donors (110), the group of institution transfers the donations to at least one global entity (125) which manages a pool of donation funds. The global entity (125) distributes and disburses the pool of donation funds based on the request of recipients (130) deserving of the donations. The recipients (130) obtain the donation funds in the form of mobile airtime credit or mobile wallet points via a plurality of kiosk terminals.

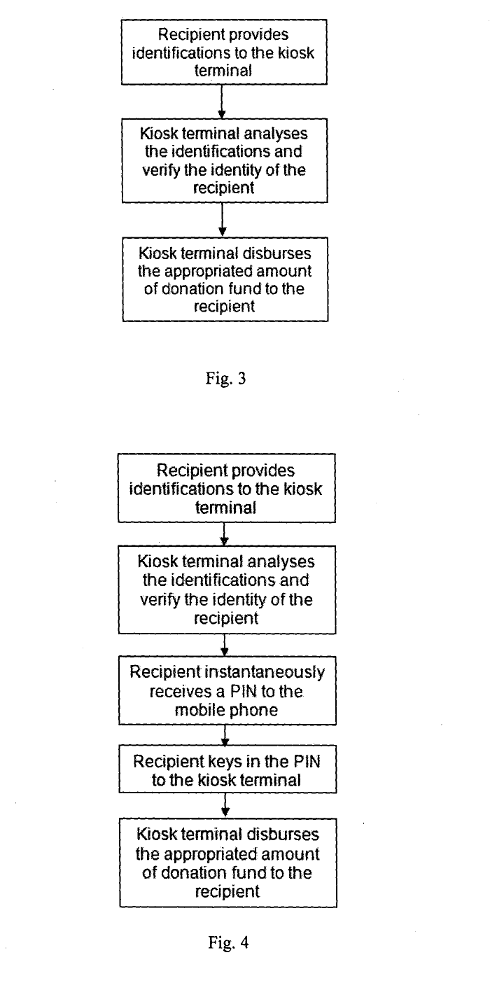

Referring now to FIG. 3, there is shown a method for disbursing the donation funds from a kiosk terminal to a recipient (130). In order to disburse the donation fund appropriated to the recipient (130) when requested at the kiosk terminal, a first step is for the recipient (130) to provide at least one identification to the kiosk terminal. The identification provided by the recipient is analysed by the kiosk terminal to compare the identity of the recipient (130) to the database of registered recipients. Once the identity of the recipient (130) is verified, the global entity (125) instructs the kiosk terminal to disburse the appropriated amount of donation fund to the corresponding recipient (130). The donation funds received by the recipients (130) are preferably in the form of mobile airtime credit or mobile wallet points but may also be in the form of cash dispensable by the kiosk terminal.

Referring now to FIG. 4, there is shown a second method for receiving the donation fund by a recipient (130) with an additional security step. The additional step is introduced once the identifications of the recipient (130) are provided to the kiosk terminal. Upon providing the identifications and verifying the identity of the recipient (130), the recipient (130) instantaneously receives a PIN sent by the global entity (125). The PIN may be send to the recipient's mobile phone via a short message service (SMS). Upon receiving the PIN, the recipient (130) keys in the PIN using the input means to the kiosk terminal to confirm that the recipient (130) is in possession of the mobile phone and is within the perimeter of the kiosk terminal. The usage of the PIN improves the security of transaction because the recipient (130) would have to be at the kiosk terminal in order to key in the instantaneously received PIN. The global entity confirms the PIN and disburses mobile airtime credit or mobile wallet points to the recipients' mobile phone. In the present invention, the PIN may be used for a one time disbursement of the donation funds or may be used for recurring disbursements in which the PIN is obtained by the recipient (130) from the donation collecting institution (120) upon registration.

The aforementioned identifications required by the kiosk terminal include but is not limited to an identity card number and a mobile phone number. The identity card number may be a number required of and unique to the recipient (130) when registering with the donation collecting institution (120). The identity card number may be a social security number. The recipient (130) provides the identity card number and the mobile phone number by keying in the numbers as requested by the kiosk terminal. Alternatively, biometric identification means such as fingerprint recognition, retina scan or face recognition may also be utilised in place of or in addition to the identity card number and the mobile phone number. In the instance where biometric identifications are used, the kiosk terminal is equipped with a fingerprint scanner, retina scanner or a camera with face recognition software.

In yet another embodiment of the present invention, instead of manually keying in the identity card number and the mobile phone number, the kiosk terminal is provided with a card reader and a sensor for verifying the identity the recipient's identity card. A scanner may also be provided to scan a barcode on the recipient's identity card. Alternatively, the sensor may also be used to verify the identity of the recipients by identifying the recipient's mobile phone using a near field communication (NFC) signal exchange between the kiosk terminal and the mobile phone. The card reader, sensor and scanner allow contact or contactless communication between the kiosk terminal and the recipient's identifications. It should be noted that the recipient's identifications may differ from one country to another and may include embedded chips, magnetic strip, barcode et cetera being incorporated to the identifications. The kiosk terminal comprises the necessary mechanism to interpret and establish a connection with the identifications and to verify the identity of the recipient before the donation fund is disbursed to the recipient (130).

The donation fund is disbursed by the global entity (125) once the recipient's identity is verified, in a fashion similar to that of reloading or topping-up a mobile phone's airtime. The global entity (125) may be linked to mobile service providers such that upon receiving disbursement instructions from the global entity (125) the corresponding mobile service provider updates the mobile account or mobile wallet account of the recipient (130) with an increase value based on the donation funds appropriated.

Alternatively, the recipient (130) may use the sensor to verify the recipient's identity based on the recipient's mobile phone using near field communication (NFC). Once the recipient's identity is verified, the mobile account or mobile wallet account is automatically topped up using NFC.

Although this disclosure has described and illustrated certain preferred embodiments of the invention, it is to be understood that the invention is not restricted to those particular embodiments. Rather, the invention includes all embodiments which are functional or mechanical equivalent of the specific embodiments and features that have been described and illustrated.

1-38. (canceled)

39. A system for facilitating the transaction of donation funds comprising:
a plurality of recipients with a corresponding mobile account;
a plurality of donors for donating the donation funds to the recipients via a plurality of kiosk terminals in the form of cash, mobile airtime credit, mobile wallet points or mobile money;
at least one donation collecting institution for receiving and gathering the donation funds received from the donors; and
at least one global entity for supervising and controlling the collected donation funds to be disbursed and distributed to the recipients;
wherein the recipient conducts self-verification over the kiosk terminals to trigger sending of a verification pin to the corresponding mobile account before receiving any donation fund therefrom and the donation funds received by the recipients are in form of mobile airtime credit, mobile wallet points or cash dispensable by the kiosk terminals.

40. The system according to claim 39, wherein the system is used for the collection of zakat or the collection of tithes.

41. The system according to claim 39, wherein the recipients are registered in the system such that the details of the recipients are stored in a recipients' details database.

42. The system according to claim 39, wherein the donors are institutions, corporations, companies and individuals.

43. The system according to claim 39, wherein the donors contribute donations to the donation collecting institution via a donors' kiosk terminal.

44. The system according to claim 43, wherein the kiosk terminal is a cash acceptance terminal.

45. The system according to claim 43, wherein the kiosk terminal is provided with a card reader, sensor and barcode scanner for detecting cards with security chip and magnetic stripe or barcodes on vouchers or tickets.

46. The system according to claim 43, wherein the kiosk terminal is provided with means for carrying out near field communication (NFC).

47. The system according to claim 43, wherein the kiosk terminal allows the donors to key in the donors' name and identification, enabling the kiosk terminal to detect and update the donors' donation fund account.

48. The system according to claim 39, wherein the plurality of donors contribute donations to the donation collecting institution via a cash deposit machine, an Automatic Teller Machine (ATM), electronic funds transfer (EFT), short messaging service (SMS) instructions, online banking, payroll deduction or over the counter services.

49. The system according to claim 39, wherein the plurality of donors contribute donations to the donation collecting institution through mobile airtime transfer in which the mobile airtime is converted to a form of currency acceptable by the institutions.

50. The system according to claim 39, wherein the donation collecting institutions are affiliated to different countries and serve as a focal point for the collection of donations from a particular country.

51. The system according to claim 39, wherein the donation collecting institutions coordinate the receipt or donations at a micro level for better monitoring and tracking.

52. The system according to claim 39, the global entity coordinates the donation funds pool at a macro level to ensure that funds can be disbursed in a more equal fashion to the highest number of recipients.

53. The system according to claim 39, wherein the mobile airtime credit and mobile wallet points are used to purchase goods or services from participating merchants or service providers.

54. The system according to claim 39, wherein the plurality of kiosk terminals are strategically placed in or within the proximity of poor or needy communities.

55. The system according to claim 39, wherein the kiosk terminal is installed with a program which allows the recipient to key in their particulars via an interface displayed on a screen.

56. The system according to claim 39, wherein the kiosk terminal comprises a card reader and sensor for detecting cards with embedded security chips and magnetic stripe.

57. The system according to claim 39, wherein the kiosk terminal comprises a scanner to establish communication between the kiosk terminal and the recipients' mobile phone.

58. A method for disbursing the donation funds from a pool of donation funds via a kiosk terminal comprising the steps of:
receiving donations from a plurality of donors via the kiosk terminal in the form of cash, mobile airtime credit, mobile wallet points or mobile money to form the pool of donation funds;
transferring the donations funds to at least one global entity which manages the pool of donation funds;
analysing and comparing the identifications provided by a recipient, to a database of registered recipient via a kiosk terminal;
verifying the identity of the recipient and sending a verification pin to the corresponding mobile phone account; and
disbursing an appropriated amount of donation fund to the corresponding recipient in the form of mobile airtime credit or mobile wallet points or cash dispensable by the kiosk terminals upon receiving the verification pin.

59. The method according to claim 58, wherein identifications are provided by the recipient by keying in an identity card number and a mobile phone number as requested by the kiosk terminal.

60. The method according to claim 58, wherein the identifications are biometric identification means such as fingerprint recognition, retina scan or face recognition.

61. The method according to claim 58, wherein the identifications are identity cards readable by card readers and sensors of the kiosk terminal or scanable by a scanner of the kiosk terminal.

62. The method according to claim 58, wherein the identification is a recipient's mobile phone identified by the kiosk terminal using a near field communication (NFC) signal exchange between the kiosk terminal and the mobile phone.

63. The method according to claim 58, wherein the step of disbursing an appropriated amount of donation fund to the corresponding recipient is achieved in a fashion similar to that of reloading or topping-up a mobile phone's airtime.

64. The method according to claim 58, wherein the step of verifying the identity of the recipient is achieved by using sensors of the kiosk terminal to verify the recipient's identity based on the recipient's mobile phone using near field communication (NFC) and the step of disbursing an appropriated amount of donation fund is achieved immediately by topping up in the recipient's mobile account or mobile wallet via NFC.

65. A method for disbursing the donation funds from a pool of donation funds via a kiosk terminal comprising the steps of:
analysing and comparing the identifications provided by a recipient to a database of registered recipient via a kiosk terminal;
verifying the identity of the recipient;
sending a Personal Identification Number (PIN) to the recipient's mobile phone via a short message service (SMS);
receiving the PIN keyed in by the recipient via the kiosk terminal; and
disbursing an appropriated amount of donation fund to the corresponding recipient via the kiosk terminal in the form of mobile airtime credit or mobile wallet points;
wherein the mobile airtime credit and/or mobile wallet points are exchangeable for goods, services and/or airtime credits to be donated to the recipients.

66. The method according to claim 65, wherein the PIN is used for a one time disbursement of the donation funds.

67. The method according to claim 65, wherein the PIN is used for recurring disbursements of the donation funds.

68. The method according to claim 65, wherein identifications are provided by the recipient by keying in an identity card number and a mobile phone number as requested by the kiosk terminal.

69. The method according to claim 65, wherein the identifications are biometric identification means such as fingerprint recognition, retina scan or face recognition.

70. The method according to claim 65, wherein the identifications are identity cards which is read by a card reader and sensor of the kiosk terminal or scanned by a scanner of the kiosk terminal.

71. The method according to claim 65, wherein the identification is a recipient's mobile phone identified by the kiosk terminal using a near field communication (NFC) signal exchange between the kiosk terminal and the mobile phone.

72. The method according to claim 65, wherein the step of disbursing an appropriated amount of donation fund to the corresponding recipient is achieved in a fashion similar to that of reloading or topping-up a mobile phone's airtime.

73. The method according to claim 65, wherein the step of disbursing an appropriated amount of donation fund is achieved by topping up in the recipient's mobile account or mobile wallet via NFC.
